(19) United States
(12) Patent Application Publication
(10) Pub. No.: US 2026/0149907 A1
(43) Pub. Date: May 28, 2026

(54) WIRELESS HEADPHONE

(71) Applicant: Tymphany HK Limited, Wanchai (HK)

(72) Inventor: Zhi-Wen CHEN, Taipei City (TW)

(21) Appl. No.: 18/956,659

(22) Filed: Nov. 22, 2024

(51) Int. Cl. H04R 1/10

(52) U.S. Cl. CPC H04R 1/10; H04R 2420/07

(57) ABSTRACT

A wireless headphone includes a sound chamber part and an earhook part. The sound chamber part is provided with a first magnetic member disposed therein. The earhook part includes a front end connecting to the sound chamber part and a rear end opposite the front end. The rear end is provided with a second magnetic member disposed therein, and the earhook part is configured to be flexibly deformed to change a distance between the sound chamber part and the rear end. When the distance is smaller than a threshold value, the first magnetic member and second magnetic member attract each other.

### TECHNICAL FIELD

The present invention relates to a wireless headphone.

### BACKGROUND OF THE INVENTION

Referring to the tables below, the applicants have analyzed diverse types of true wireless stereo (TWS) headphones that are currently available.

| Types of TWS | Semi in-ear | | Open-ear |
|---|---|---|---|
| headphone | headphone | In-ear headphone | headphone |
| Method for | semi-coupling | strong-coupling | weak-coupling |
| retaining the | | | |
| headphone to | | | |
| the ear | | | |
| Typical types of | flat earbud | In-ear silicone ear | bone-conduction |
| Products | | tip | headphone, air- |
| | | | conduction |
| | | | headphone |
| Technical | Good sound | Good sound | The ear canal is |
| Features | quality; | quality with more | completely open, |
| | Comfortable to | low-frequency | which is conducive |
| | wear; the | volume; | to receiving |
| | headphone is | By using a silicone | sounds from the |
| | mainly worn at | ear tip to seal the | surrounding |
| | the cavitas | ear canal, the | environment, |
| | conchae and the | sound insulation | ensuring safety |
| | entrance of the | effect is good, and | during exercise, |
| | ear canal, and will | it is also suitable | and providing |
| | not invade the ear | for the TWS | music and call |
| | canal and cause | design with active | services to avoid |
| | discomfort; | noise cancellation | boredom during |
| | average sound | (ANC) technology | exercise |
| | insulation effect | | |
| Disadvantages of | The bass is weak, | Wearing comfort | Average sound |
| the product | such that a larger | is frequently | quality with |
| | diameter | criticized, it is not | narrow |
| | headphone unit is | suitable for people | bandwidth, lack of |
| | required; | with oily ears, and | bass and treble |
| | The passive noise | the intrusive in- | details; |
| | reduction effect is | ear design tends | The sound leakage |
| | not good, and | to make people | is serious and |
| | there are few | uncomfortable | disturbs other |
| | semi-in-ear | and their ears | people; |
| | TWS + ANC | swollen and | No noise |
| | products | painful; | insulation; the |
| | | More likely to | volume usually |
| | | cause hearing loss; | needs to be |
| | | today 1 in 5 | turned up when |
| | | people worldwide | the user is out or |
| | | have hearing | on the way to |
| | | problems | work; |
| | | | Usually a larger |
| | | | sound unit is |
| | | | required, which |
| | | | consumes more |
| | | | power and |
| | | | reduces battery |
| | | | life. |
| Application | Portable, for | Portable, for | Suitable for sport |
| Scenarios | listening to music, | listening to music, | activities only |
| | making phone | making phone | (when running, |
| | calls | calls; | cycling, etc.) |
| | | Commuting and | |
| | | other scenarios | |
| | | requiring noise | |
| | | reduction | |

Generally, open-ear TWS headphones are only suitable to serve as sport headphones, which are a niche market. However, with the increasing emphasis on fitness and hearing protection, open-ear headphones have taken on a variety of forms, as well as being combined with eyewear or jewelry.

To compare and analyze open-ear TWS headphones, Graph 1000 in FIG. 1 shows the equivalent frequency response curves of the bone-conduction+air-conduction hybrid type product and the air-conduction headphone worn on the head and torso simulator (HATS), wherein the horizontal axis represents the frequency in Hz, the vertical axis represents the sound pressure level in dB, curve 1001 represents the bone-conduction+air-conduction hybrid type product, and curve 1002 represents the air-conduction headphone.

The bone-conduction unit of the bone-conduction headphone is a miniaturized vibration unit, which utilizes dynamic driver technology. Compared with the air-conduction headphone, the bone-conducted product has no major differences in the magnetic circuit and the voice coil, the main differences being in the vibration transmitting sheet (damper) and the vibration plate. Measuring the performance of a bone-conduction unit is similar to measuring the performance of a vibration motor in that it is usually evaluated by using an accelerometer or a Klippel analyzer. Bone-conduction headphones allow clearer reception of the human voice but are only suitable for listening to music and talking in a quiet environment. In addition, the application of bone-conduction headphones is relatively limited; such headphones are usually suitable for cycling, running and other similar scenarios. Furthermore, bone-conduction headphones have obvious disadvantages: poor bass, insufficient loudness, the need for medium and high frequencies to be supplemented by air-conduction, slight sound leakage, a volume setting of 80% or more generating a significant vibration, fatigue due to the wearing position being close to the human temple, easy heating of the bone-conduction unit when the volume is high, and the consumption of large amounts of electricity. Compared to in-ear products, bone conduction products lack balance, dynamic impact resistance, high-frequency performance, and low-frequency performance, and their output volume is low.

The majority of open-ear TWS headphones are air-conducting headphones. In a commercial open-ear air-conduction headphone incorporated into eyewear, for example, the open-ear air-conduction headphone is provided with a 16 mm driver, a PU (polyurethane) frame, and a paper cone, and it is also has a 25 mm distance between an air outlet and the ear canal inlet, a sound chamber and an air outlet. Graph 2000 in FIG. 2 shows the equivalent frequency response curve simulated and measured using the Knowles Electronics Manikin for Acoustic Research (KEMAR), in which the horizontal axis represents the frequency in Hz, the left vertical axis represents the sound pressure level in dB, the right vertical axis represents the sound resistance in Ω, the curve 2001 represents the data simulated by KEMAR, and the curve 2002 represents the data measured by KEMAR.

FIG. 3 and FIG. 5 show schematic diagrams of an alternative open-ear headphone 300 in various wearing positions on the ear. FIG. 4 and FIG. 6 respectively show enlarged views of the ear in FIG. 3 and FIG. 5. At the position of the headphone 300 shown in FIG. 3 and FIG. 4, the distance between the sound hole of the headphone 300 and the ear canal inlet is 9 mm. At the position of the headphone 300 shown in FIG. 5 and FIG. 6, the distance between the sound hole of the headphone 300 and the ear canal inlet is 16 mm. Graph 3000 of FIG. 7 presents a comparison of the embodiments shown in FIG. 3 and FIG. 5 with the curve 2002 in FIG. 2, in which the horizontal axis represents the frequency in Hz, the vertical axis represents the sound pressure level in dB, the curve 3001 represents the embodiment shown in FIG. 3 and FIG. 4, and the curve 3002 represents the embodiment shown in FIG. 5 and FIG. 6. The figures clearly illustrate that, even though these are open-ear headphones, the relative position of the headphone sound hole with respect to the ear is very important. The relative position not only affects the Industrial Design (ID) of the headphones but also directly affects the acoustic performance and the selection of driver units. Headphone sound holes need to be as close as possible to the ear canal. When the distance between the headphone sound hole and the ear canal inlet decreases, the sensitivity of the headphone is significantly increased. For example, for the same headphone 300 in FIG. 3 and FIG. 5, the sound pressure level in the wearing position shown in FIG. 5 is 15 dB more than that in the wearing position shown in FIG. 3. Nevertheless, it is still necessary to consider the proper wearing style of the sound chamber part to optimize wearing comfort.

According to market research, although on-air headphones include bone conduction headphones and air-conduction headphones, air-conduction headphones dominate the market because of their better cost-performance ratio. Current headphone wearing styles include open-ear, in-ear, semi-in-ear, and ear-hook, all of which require a wearable design based on the characteristic dimensions of the human outer ear. All current open-ear headphones are designed and arranged around the outer contour of the human ear.

### SUMMARY OF THE INVENTION

In order to solve the problems in the prior art, the present invention is related to a wireless headphone that enables rapid changeover to multiple wearing styles so as to improve the wearing comfort of the wireless headphone.

In order to achieve the above object, the present invention discloses a wireless headphone including a sound chamber part and an earhook part. The sound chamber part is provided with a first magnetic member disposed therein. The earhook part includes a front end connecting to the sound chamber part and a rear end opposite the front end. The rear end is provided with a second magnetic member disposed therein, and the earhook part is configured to be flexibly deformed to change a distance between the sound chamber part and the rear end. When the distance between the sound chamber part and the rear end is smaller than a threshold value, the first magnetic member and second magnetic member attract each other.

In some embodiments, the earhook part is configured to hang on an ear of a user, and when the distance between the sound chamber part and the rear end is smaller than a threshold value, the sound chamber part and the rear end respectively rest against opposite edges of the ear.

In some embodiments, when the distance between the sound chamber part and the rear end is smaller than the threshold value, the sound chamber part rests against a cavitas conchae of the ear without overlapping an ear canal inlet of the ear.

In some embodiments, the sound chamber part is provided with a sound hole, and when the sound chamber part rests against a cavitas conchae of the ear, a distance between the sound hole and the ear canal inlet is 3 mm to 8 mm.

In some embodiments, when the sound chamber part rests against a cavitas conchae of the ear, the rear end is in contact with the cavitas conchae.

In some embodiments, when the sound chamber part rests against a cavitas conchae of the ear, the earhook part has a curvature fitting a profile of the ear.

In some embodiments, the earhook part is configured to hang on an ear of a user, and when the sound chamber part rests close to the ear canal inlet, the distance between the sound chamber part and the rear end is larger than the threshold value.

In some embodiments, the sound chamber part is provided with a sound hole, and when the sound chamber part rests close to the ear canal inlet, the sound hole faces the ear canal inlet.

In some embodiments, when the sound chamber part rests close to the ear canal inlet, the sound hole is flush with the ear canal inlet.

In some embodiments, the wireless headphone further includes an ear tip disposed on the sound chamber part, and when the sound chamber part rests close to the ear canal inlet, the ear tip is inserted into an ear canal of the ear.

The present invention also discloses a wireless headphone including a sound chamber part and an earhook part. The sound chamber part is provided with a sound hole. The earhook part includes a first end and a second end and is provided with a first configuration and a second configuration. The first end is connected to the sound chamber part, and the earhook part is configured to be flexibly deformed to change a distance between the sound chamber part and the second end. When the distance between the sound chamber part and the second end is smaller than a threshold value, the earhook part transforms from the first configuration to the second configuration, wherein the sound chamber part is supported above an ear canal inlet of an ear of a user under the first configuration, and the sound chamber part and the second end respectively rest against opposite edges of the ear of the user under the second configuration.

The present invention provides several advantages as follows.

The wireless headphone of the present invention is flexible and deformable. Therefore, by pressing in the direction of the arrow in FIG. 11, the shape of the wireless headphone is deformed into the shape shown in FIG. 13, or the wireless headphone can be pressed in the opposite direction to change a distance between the sound chamber part and the rear end. When the wireless headphone hangs on the ear, the wireless headphone is able to be worn in the semi-in-ear style, as shown in FIG. 11. Alternatively, if the mutual attraction of the first magnetic member and the second magnetic member are used to clip the wireless headphone to the ear, as shown in FIG. 13, the wireless headphone is able to be worn in the open-ear style. The earhook is configured to be flexibly deformed, which improves the comfort of wearing the wireless headphone and allows for quick changes in wearing styles.

### BRIEF DESCRIPTION OF DRAWINGS

FIG. 1 shows the equivalent frequency response curves of the bone-conduction+air-conduction hybrid headphone and the air-conduction headphone worn on the Head and Torso Simulator (HATS).

FIG. 2 shows the equivalent frequency response curve simulated and measured using KEMAR for an open-ear air-conduction headphone incorporated into an eyewear.

FIG. 3 and FIG. 5 show schematic diagrams of an alternative open-ear headphone in various wearing positions on the ear.

FIG. 4, and FIG. 6 respectively show enlarged views of the ear in FIG. 3 and FIG. 5.

FIG. 7 shows a graph to illustrate a comparison of the embodiments shown in FIG. 3 and

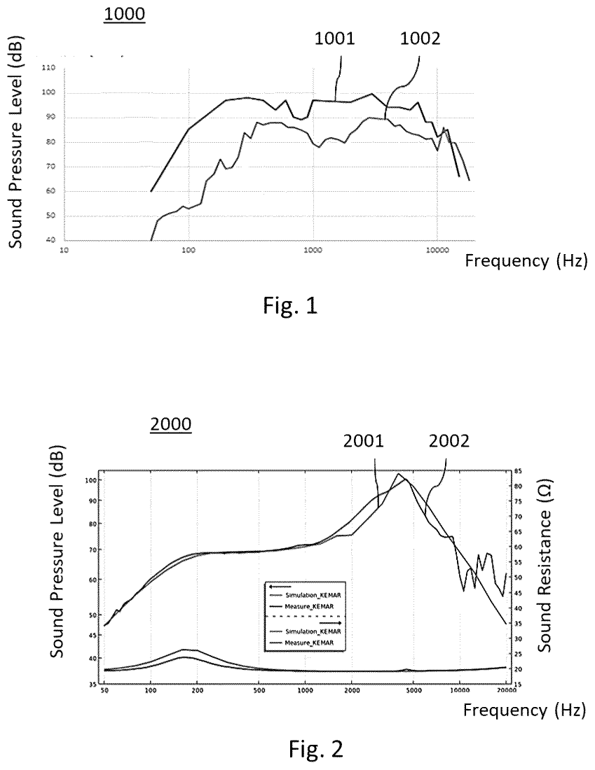

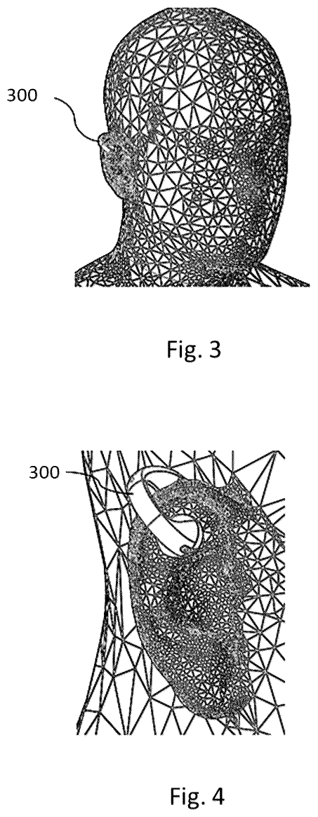

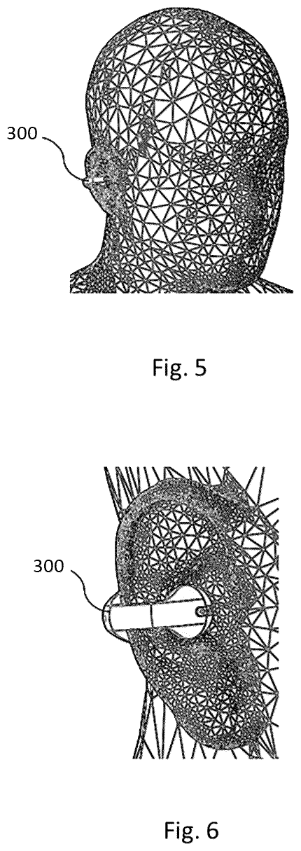

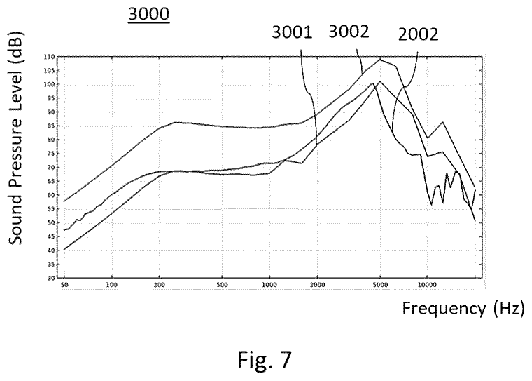

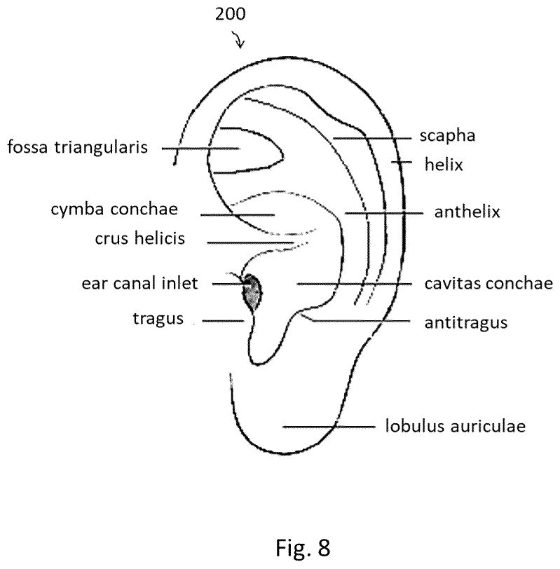

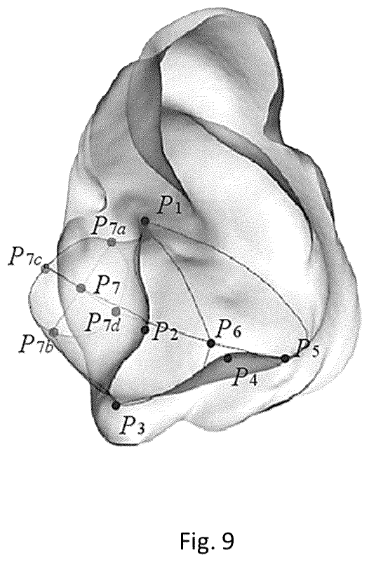

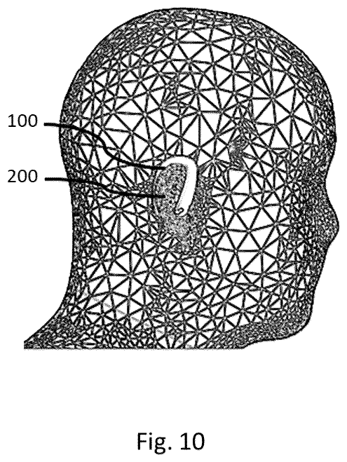

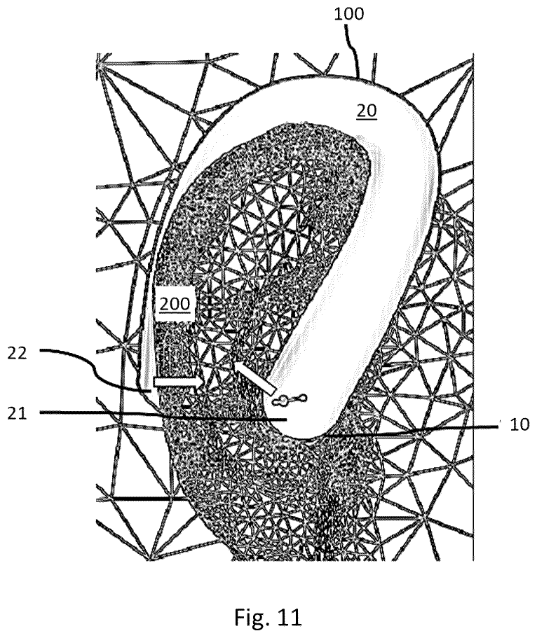

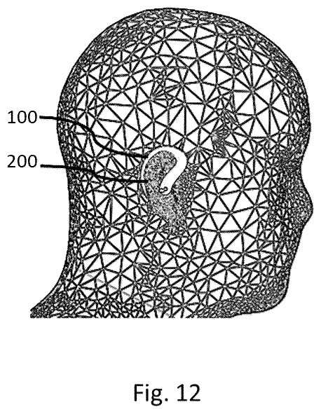

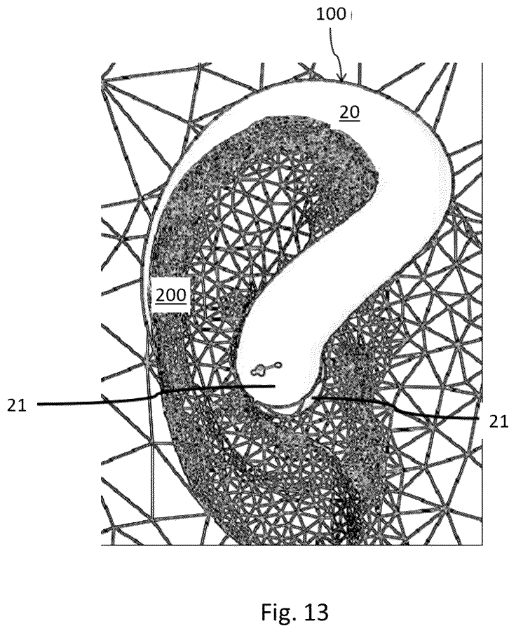

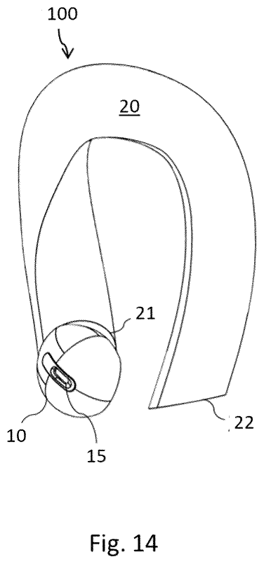

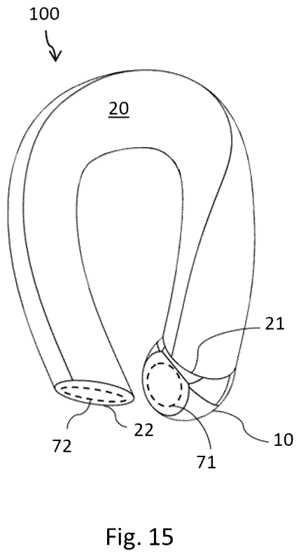

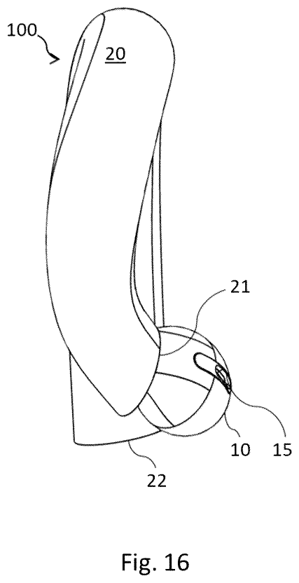

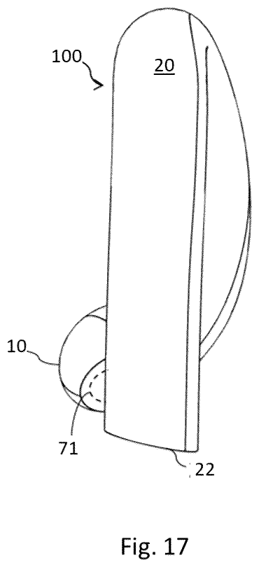

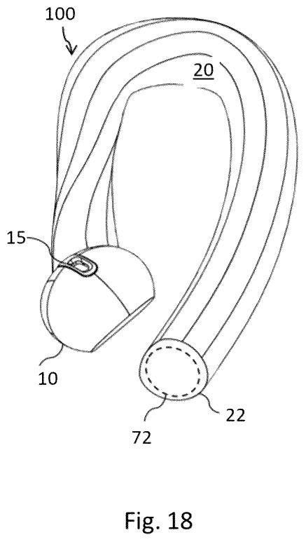

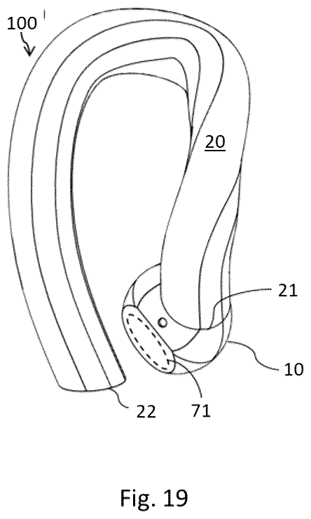

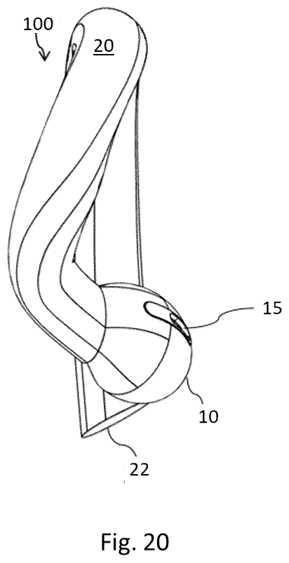

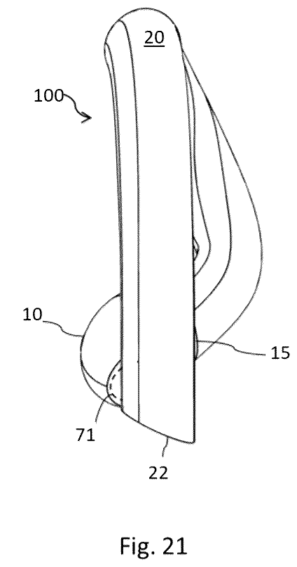

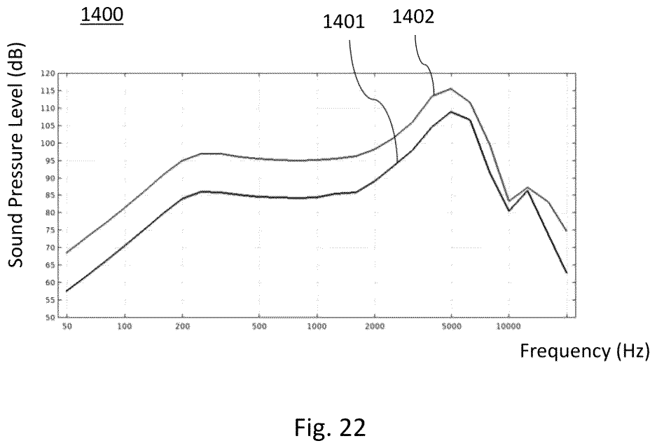

FIG. 5 with the curve in FIG. 2.

FIG. 8 shows the ear of a user.

FIG. 9 shows the inner surface of the ear.

FIG. 10 and FIG. 12 respectively show schematic diagrams of an embodiment of the wireless headphone of the present invention in a first configuration and a second configuration when the wireless headphone is worn on the ear.

FIG. 11 and FIG. 13 respectively show enlarged views of the ear in FIG. 10 and FIG. 12.

FIG. 14 to FIG. 17 show schematic views of the structure of the first configuration of an embodiment of the wireless headphone of the present invention from different viewing angles.

FIG. 18 to FIG. 21 show schematic views of the structure of the second configuration of an embodiment of the wireless headphone of the present invention from different viewing angles.

FIG. 22 shows a graph illustrating acoustic simulation data for an embodiment of the wireless headphone of the present invention.

### DETAILED DESCRIPTION OF THE INVENTION

To better understand the embodiments of the present invention, further descriptions are provided below in conjunction with some preferred embodiments of the present invention.

Embodiments of this application will be described in detail below. Throughout the present invention, identical or similar components and components having the same or similar functions are indicated by markings similar to those in the accompanying drawings. The embodiments of the drawings described herein are descriptive and illustrative and are intended to provide a basic understanding of the present invention. An embodiment of the present invention described herein shall not be construed as a restriction on the present invention.

For example, the terms “roughly”, “approximately”, “substantially” and “about” are used in the present invention to describe and illustrate minor changes. When used in conjunction with an event or situation, the term may refer to an example in which the event or circumstance occurs precisely and an example in which the event or circumstance occurs in a very close approximum.

In the present invention, unless otherwise specified or defined, relative terms such as: “central”, “longitudinal”, “lateral”, “front”, “rear”, “right”, “left”, “internal”, “external”, “lower”, “higher”, “horizontal”, “vertical”, “higher than”, “lower than”, “above”, “below”, “top”, “bottom” and their derivatives (e.g. “horizontally”, “downward”, “upward” and so on) should be interpreted as indicating the direction described in the discussion or depicted in the drawings. These terms of relativity are used for descriptive convenience only and do not require that the application be constructed or operated in a particular direction.

For the sake of description, “first”, “second”, “third”, etc., can be used in the present invention to distinguish different components in a drawing or in a series of drawings. “First”, “second”, “third”, etc. are not intended to describe the corresponding components.

FIG. 8 shows an ear 200 of a user. FIG. 9 shows the inner surface of the ear 200. In the above-mentioned drawings, P1 is located at the lower edge of the cymba conchae, P2 is located at the top point of the tragus, P3 is located at the notch (intertragic notch) between the tragus and the antitragus, P4 is located at the top point of the antitragus, P5 is located on the right edge of the antitragus, P6 is located at the lowest point of the cavitas conchae, and P7 is the ear canal inlet. The connecting lines of P7a through P7d show the contours of the ear canal inlet. In the view shown in FIG. 9, the ear canal inlet is sheltered by the tragus, such that the ear canal inlet cannot be seen in FIG. 9. FIG. 9 shows the contour of the ear canal inlet in a translucent manner to illustrate the location of the ear canal inlet.

FIG. 10 and FIG. 12 respectively show schematic diagrams of the wireless headphone 300 of an embodiment of the present invention in a first configuration and a second configuration when the wireless headphone 100 is worn on the ear 200. FIG. 11 and FIG. 13 respectively show enlarged views of the ear in FIG. 10 and FIG. 12, wherein in the view presented in FIG. 11, the sound chamber part 10 is sheltered by the earhook part 20 and only part of the right edge is visible, and in the view presented in FIG. 13, the rear end 22 is obstructed from view by the ear 200 and thus is not shown in FIG. 13. FIG. 14 to FIG. 17 show schematic views of the structure of the first configuration of an embodiment of the wireless headphone of the present invention at different angles.

FIG. 18 to FIG. 21 show schematic views of the structure of the second configuration of an embodiment of the wireless headphone of the present invention at different angles. The embodiment of the present invention discloses a wireless headphone 100 including a sound chamber part 10 and an earhook part 20. The sound chamber part 10 is provided with a first magnetic member 71 disposed therein; please see FIG. 15, FIG. 17, FIG. 19 and FIG. 21. Since the first magnetic member 71 is an internally disposed component and obstructed from view, it is illustrated with dashed lines in these drawings. The earhook part 20 includes a front end 21 connecting to the sound chamber part 10 and a rear end 22 opposite the front end 21. The rear end 22 is provided with a second magnetic member 72 disposed therein; please see FIG. 15 and FIG. 18. Since the second magnetic member 72 is an internally disposed component and obstructed from view, it is illustrated with dashed lines in these drawings.

The earhook part 20 is configured to be flexibly deformed to change a distance between the sound chamber part 10 and the rear end 22. When the distance between the first magnetic member 71 and the second magnetic member 72 or the distance between the sound chamber part 10 and the rear end 22 is smaller than a threshold value, the first magnetic member 71 and second magnetic member 72 attract each other. The wireless headphone 100 of the present invention is flexible and deformable. Therefore, if pressure is applied in the direction of the arrow in FIG. 11, the shape of the wireless headphone 100 is deformed into the shape shown in FIG. 13, or the wireless headphone 100 can be pressed in the opposite direction to change the distance between the sound chamber part 10 and the rear end 22. When the wireless headphone 100 hangs on the ear 200, the wireless headphone 100 is able to be worn in the semi-in-ear style, as shown in FIG. 11; alternatively, if the mutual attraction of the first magnetic member 71 and the second magnetic member 72 is used to clip the wireless headphone 100 to the ear 200 as shown FIG. 13, the wireless headphone 100 is able to be worn in the open-ear style. The earhook part 20 is configured to be flexibly deformed, which improves the comfort of wearing the wireless headphone 100.

The present invention discloses a wireless headphone 100 including a sound chamber part 10 and an earhook part 20. The sound chamber part 10 is provided with a sound hole 15. The earhook part 20 includes a first end (front end 21) and a second end (rear end 22) and is provided with a first configuration, as shown in FIG. 10 to FIG. 11 and FIG. 14 to FIG. 17, and a second configuration, as shown in FIG. 12 to FIG. 13 and FIG. 18 to FIG. 21. The first end (front end 21) is connected to the sound chamber part 10, and the earhook part 20 is configured to be flexibly deformed to change the distance between the sound chamber part 10 and the second end (rear end 22). When the distance between the sound chamber part 10 and the second end (rear end 22) is smaller than the threshold value, the earhook part 20 is deformed from the first configuration to the second configuration, wherein the sound chamber part 10 rests against an ear canal inlet of the user under the first configuration and the sound chamber part 10 and the second end (rear end 22) respectively rest against opposite edges of the ear of the user under the second configuration. Furthermore, using the first magnetic part 71 and the second magnetic part 72 is not a necessary approach in the present invention, for in an alternative approach, the earhook part 20 can be made of a shape memory material. The transformation between the first configuration and the second configuration can be realized by the flexible deformation of the earhook part 20 to change the distance between the first end (front end 21) and the second end (rear end 22) and further change the distance between the sound chamber part 10 and the second end (rear end 22) to implement different wearing styles of the wireless headphone 100.

In the embodiment of the semi-in-ear wearing style shown in FIG. 10 and FIG. 11, the earhook part 20 is configured to hang on the ear 200 of the user, and the sound chamber part 10 rests close to the ear canal inlet of the ear 200. That is, the front side of the sound chamber part 10 is close to the point P7 in FIG. 9. At this time, the distance between the rear end 22 and the sound chamber part 10 is larger than the threshold value, and the first magnetic member 71 and the second magnetic member 72 do not function. The sound hole 15 of the sound chamber part 10 faces the ear canal inlet (see FIG. 14, FIG. 16, FIG. 18 and FIG. 20), and the sound hole 15 is flush with the ear canal inlet.

In the embodiment of the open-ear wearing style shown in FIG. 12 and FIG. 13, when the earhook part 20 is configured to hang on the ear 200 of the user, the distance between the rear end 22 and the sound chamber part 10 (the thickness of the ear 200 at the point P5/P6 shown in FIG. 9) is less than the threshold value, and the first magnetic member 71 and second magnetic member 72 attract each other. Thus, the sound chamber part 10 and the rear end 22 respectively rest against opposite edges of the ear 200 so as to retain the wireless headphone on the ear 200. The sound chamber part 10 rests against the cavitas conchae of the ear 200. That is, the rear side of the sound chamber part 10 rests against points P5/P6 in FIG. 9, and the sound chamber part 10 does not overlap the ear canal inlet. The distance between the sound hole 15 of the sound chamber part 10 and the ear canal inlet is 3 mm to 8 mm, or for example, 5 mm. The rear end 22 of the earhook part 20 is also in contact with the cavitas conchae, and the earhook part 20 has a curvature fitting a profile (the tuberculum auriculae) of the ear 20.

In the embodiment of the semi-in-ear wearing style shown in FIG. 10 and FIG. 11, the earhook part 20 is not required to tightly rest against the ear 200. Instead, the sound chamber part 10 is supported between the tragus and the antitragus of the ear and rests close to the ear canal inlet to fix the sound chamber part 10. The earhook part 20 is straight except for the bending portion. When the open-ear wireless headphone is worn as shown in FIG. 12 and FIG. 13, the earhook part 20 rests against the ear 200 along with the sound chamber part 10. Since the earhook part 20 is configured to be flexibly deformed, the shape of the earhook part 20 can be deformed to have a curvature fitting a profile (the tuberculum auriculae) of the ear 20, thereby being more comfortable to wear.

In other embodiments, the wireless headphone 100 further includes an ear tip disposed on the sound chamber part 10. On the basis of the semi-in-ear wearing style shown in FIG. 11, the ear tip is inserted into an ear canal of the ear 200 to implement the in-ear wearing style of the wireless headphone 100. In one example, the ear tip is a silicone ear tip to seal the ear canal with the wireless headphone 100.

As shown in graph 1400 in FIG. 22, the headphone unit of the wireless headphone 10 and the sound chamber part 10 were used to perform acoustic simulation on the KEMAR head, and the sound pressure level at the tympanic membrane was extracted for comparison; in graph 1400 in FIG. 22, the horizontal axis represents the frequency in Hz, the vertical axis represents the sound pressure level in dB, the curve 1401 represents the embodiment of the open-ear wearing style shown in FIG. 12 and FIG. 13, and the curve 1402 represents the embodiment of the semi-in-ear wearing style shown in FIG. 10 and FIG. 11.

As shown in graph 1400 in FIG. 22, the sound pressure level of the semi-in-ear wearing style is 10 dB higher than that of the open-ear wearing style.

The present invention provides a novel TWS (True Wireless Stereo) headphone with at least two wearing styles (open-ear and semi-in-ear). Having an earhook design with simple structure (such as magnetic force design), the headphone of the present invention allows easy adjustment of the wearing style. Through reasonable driver unit selection and sound chamber design, the headphone of the present invention ensures that the semi-in-ear wearing style (music mode) has excellent music quality and the open-ear wearing style (sports mode) can allow easy perception of the ambient sound and ensure safety while still providing a satisfactory music experience. Consumers only need to buy one set of headphones to meet their daily sports and music listening needs at the same time.

The foregoing is only a preferred embodiment of the present invention and is not intended to limit the present invention, as people having ordinary skill in the art may note that the present invention may have various alterations and variations. Any modification, equivalent replacement, improvement, etc., made within the spirit and principles of the present invention shall be included in the scope of protection of the present invention.

1. A wireless headphone, comprising:
a sound chamber part provided with a first magnetic member disposed therein; and
an earhook part, comprising:
a front end connected to the sound chamber part; and
a rear end, opposite the front end, provided with a second magnetic member disposed therein
wherein the earhook part is configured to be flexibly deformed to change a distance between the sound chamber part and the rear end, and
wherein, when the distance between the sound chamber part and the rear end is smaller than a threshold value, the first magnetic member and second magnetic member attract each other.

2. The wireless headphone as claimed in claim 1, wherein the earhook part is configured to hang on an ear of a user, and when the distance between the sound chamber part and the rear end is smaller than the threshold value, the sound chamber part and the rear end respectively rest against opposite edges of the ear.

3. The wireless headphone as claimed in claim 2, wherein when the distance between the sound chamber part and the rear end is smaller than the threshold value, the sound chamber part rests against a cavitas conchae of the ear without overlapping an ear canal inlet of the ear.

4. The wireless headphone as claimed in claim 3, wherein the sound chamber part is provided with a sound hole, and when the sound chamber part rests against a cavitas conchae of the ear, a distance between the sound hole and the ear canal inlet is 3 mm to 8 mm.

5. The wireless headphone as claimed in claim 3, wherein, when the sound chamber part rests against a cavitas conchae of the ear, the rear end is in contact with the cavitas conchae.

6. The wireless headphone as claimed in claim 3, wherein, when the sound chamber part rests against a cavitas conchae of the ear, the earhook part has a curvature fitting a profile of the ear.

7. The wireless headphone as claimed in claim 1, wherein the earhook part is configured to hang on an ear of a user, and when the sound chamber part rests close to the ear canal inlet, the distance between the sound chamber part and the rear end is larger than the threshold value.

8. The wireless headphone as claimed in claim 7, wherein the sound chamber part is provided with a sound hole, and when the sound chamber part rests close to the ear canal inlet, the sound hole faces the ear canal inlet.

9. The wireless headphone as claimed in claim 8, wherein when the sound chamber part rests close to the ear canal inlet, the sound hole is flush with the ear canal inlet.

10. The wireless headphone as claimed in claim 7, further comprising an ear tip disposed on the sound chamber part,
wherein when the sound chamber part rests close to the ear canal inlet, the ear tip is inserted into an ear canal of the ear.

11. A wireless headphone, comprising:
a sound chamber part, provided with a sound hole; and
an earhook part, including a first end and a second end, and provided with a first configuration and a second configuration,
wherein the first end is connected to the sound chamber part, and the earhook part is configured to be flexibly deformed to change a distance between the sound chamber part and the second end, and when the distance between the sound chamber part and the second end is smaller than a threshold value, the earhook part transforms from the first configuration to the second configuration, and
wherein the sound chamber part is supported above an ear canal inlet of an ear of a user under the first configuration, and the sound chamber part and the second end rest against opposite edges of the ear of the user under the second configuration.
